(19) United States
(12) Patent Application Publication
(10) Pub. No.: US 2003/0218638 A1
(43) Pub. Date: Nov. 27, 2003

(54) Mobile multimodal user interface combining 3D graphics, location-sensitive speech interaction and tracking technologies

(76) Inventors: Stuart Goose, Princeton, NJ (US); Georg J. Schneider, Merzig (DE); Heiko Wanning, Hamburg (DE)

Correspondence Address: Siemens Corporation, Intellectual Property Department, 170 Wood Avenue South, Iselin, NJ, 08830, US

(21) Appl. No.: 10/358,949

(22) Filed: Feb. 5, 2003

Related U.S. Application Data
(60) Provisional application No. 60/355,524, filed on Feb. 6, 2002.

(51) Int. Cl. G09G 5/00

(52) U.S. Cl. 345/850

(57) ABSTRACT

A mobile reality apparatus, system and method for navigating a site are provided. The method includes the steps of determining a location of a user by receiving a location signal from a location-dependent device; loading and displaying a 3D scene of the determined location; determining an orientation of the user; adjusting a viewpoint of the 3D scene by the determined orientation; determining if the user is within a predetermined distance of an object of interest; and loading a speech dialog of the object of interest. The system includes a plurality of location-dependent devices for transmitting a signal indicative of each devices' location; and a navigation device including a tracking component for determining a position and orientation of the user; a graphic management component for displaying scenes of the site to the user on a display; and a speech interaction component for instructing the user.

### PRIORITY

This application claims priority to an application entitled “A MOBILE MULTIMODAL USER INTERFACE COMBINING 3D GRAPHICS, LOCATION-SENSITIVE SPEECH INTERACTION AND TRACKING TECHNOLOGIES” filed in the United States Patent and Trademark Office on Feb. 6, 2002 and assigned Serial No. 60/355,524, the contents of which are hereby incorporated by reference.

### BACKGROUND OF THE INVENTION

1. Field of the Invention

The present invention relates generally to augmented reality systems, and more particularly, to a mobile augmented reality system and method thereof for navigating a user through a site by synchronizing a hybrid tracking system with three-dimensional (3D) graphics and location-sensitive interaction.

2. Description of the Related Art

In recent years, the remarkable commercial success of small screen devices, such as cellular phones and Personal Digital Assistants (PDAs) has become prevalent. Inexorable growth for mobile computing devices and wireless communication has been predicted by recent market studies. Technology continues to evolve, allowing an increasingly peripatetic society to remain connected without any reliance upon wires. As a consequence, mobile computing is a growth area and the focus of much energy. Mobile computing heralds exciting new applications and services for information access, communication and collaboration across a diverse range of environments.

Keyboards remain the most popular input device for desktop computers. However, performing input efficiently on a small mobile device is more challenging. This need continues to motivate innovators. Speech interaction on mobile devices has gained in currency over recent years, to the point now where a significant proportion of mobile devices include some form of speech recognition. The value proposition for speech interaction is clear: it is the most natural human modality, can be performed while mobile and is hands-free.

Although virtual reality tools are used for a multitude of purposes across a number of diverse markets, it has yet to become widely deployed and used in mainstream computing. The ability to model real world environments and augment them with animations and interactivity has benefits over conventional interfaces. However, navigation and manipulation in 3D graphical environments can be difficult, and disorientating, especially when using a conventional mouse.

Therefore, a need exists for systems and methods for employing virtual reality tools in a mobile computing environment. Additionally, the systems and methods should support multimodal interfaces for facilitating one-handed or hands-free operation.

### SUMMARY OF THE INVENTION

A mobile reality framework is provided that synchronizes a hybrid tracking solution to offer a user a seamless, location-dependent, mobile multi-modal interface. The user interface juxtaposes a three-dimensional (3D) graphical view with a context-sensitive speech dialog centered upon objects located in an immediate vicinity of the mobile user. In addition, support for collaboration enables shared three dimensional graphical browsing with annotation and a full-duplex voice channel.

According to an aspect of the present invention, a method for navigating a site includes the steps of determining a location of a user by receiving a location signal from a location-dependent device; loading and displaying a three-dimensional (3D) scene of the determined location; determining an orientation of the user by a tracking device; adjusting a viewpoint of the 3D scene by the determined orientation; determining if the user is within a predetermined distance of an object of interest; and loading a speech dialog of the object of interest. The method further includes the step of initiating by the user a collaboration session with a remote party for instructions.

According to another aspect of the present invention, a system for navigating a user through a site is provided. The system includes a plurality of location-dependent devices for transmitting a signal indicative of each devices' location; and

a navigation device for navigating the user including: a tracking component for receiving the location signals and for determining a position and orientation of the user; a graphic management component for displaying scenes of the site to the user on a display; and a speech interaction component for instructing the user.

According to a further aspect of the present invention, a navigation device for navigating a user through a site includes a tracking component for receiving location signals from a plurality of location-dependent devices and for determining a position and orientation of the user; a graphic management component for displaying scenes of the site to the user on a display; and a speech interaction component for instructing the user.

According to yet another aspect of the present invention, a program storage device readable by a machine, tangibly embodying a program of instructions executable by the machine to perform method steps for navigating a site is provided, the method steps including determining a location of a user by receiving a location signal from a location-dependent device; loading and displaying a three-dimensional (3D) scene of the determined location; determining an orientation of the user by a tracking device; and adjusting a viewpoint of the 3D scene by the determined orientation; determining if the user is within a predetermined distance of an object of interest; and loading a speech dialog of the object of interest.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is a block diagram of the application framework enabling mobile reality according to an embodiment of the present invention;

FIG. 2 is a flow chart illustrating a method for navigating a user through a site according to an embodiment of the present invention;

FIG. 3 is flow chart illustrating a method for speech interaction according to an embodiment of the mobile reality system of the present invention;

FIG. 4 is an exemplary screen shot of the mobile reality apparatus illustrating co-browsing with annotation;

FIG. 5 is a schematic diagram of an exemplary mobile reality apparatus in accordance with an embodiment of the present invention; and

FIG. 6 is an augmented floor plan where FIG. 6(a) illustrates proximity sensor regions and infrared beacon coverage zones and FIG. 6(b) shows the corresponding VRML viewpoint for each coverage zone.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A mobile reality system and method in accordance with embodiments of the present invention offers a mobile multimodal interface for assisting with tasks such as a mobile maintenance. The mobile reality systems and methods enable a user equipped with a mobile device, such as a PDA (personal digital assistant) running Microsoft's™ Pocket PC operating system, to walk around a building and be tracked using a combination of techniques while viewing on the mobile device a continuously updated corresponding personalized 3D graphical model. In addition, the systems and methods of the present invention also integrate text-to-speech and speech-recognition-technologies that enables the user to engage in a location/context sensitive speech dialog with the system.

Generally, an augmented reality system includes a display device for presenting a user with an image of the real world augmented with virtual objects, a tracking system for locating real-world objects, and a processor, e.g., a computer, for determining the user's point of view and for projecting the virtual objects onto the display device in proper reference to the user's point of view.

Mixed and augmented reality techniques have focused on overlaying synthesized text or graphics onto a view of the real world, static real images or 3D scenes. The mobile reality framework of the present invention now adds another dimension to augmentation. As speech interaction is modeled separately from the three dimensional graphics, it is specified in external XML resources, it is now easily possible to augment the 3D scene and personalize the interaction in terms of speech. Using this approach, the same 3D scene of the floor plan can be personalized in terms of speech interaction for a maintenance technician, electrician, HVAC technician, office worker, etc.

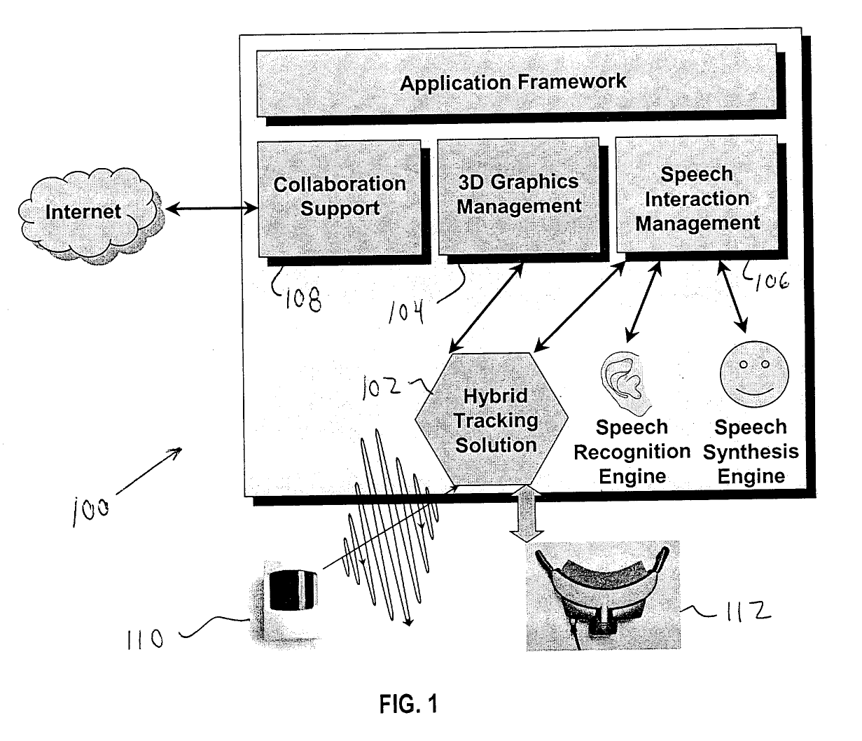

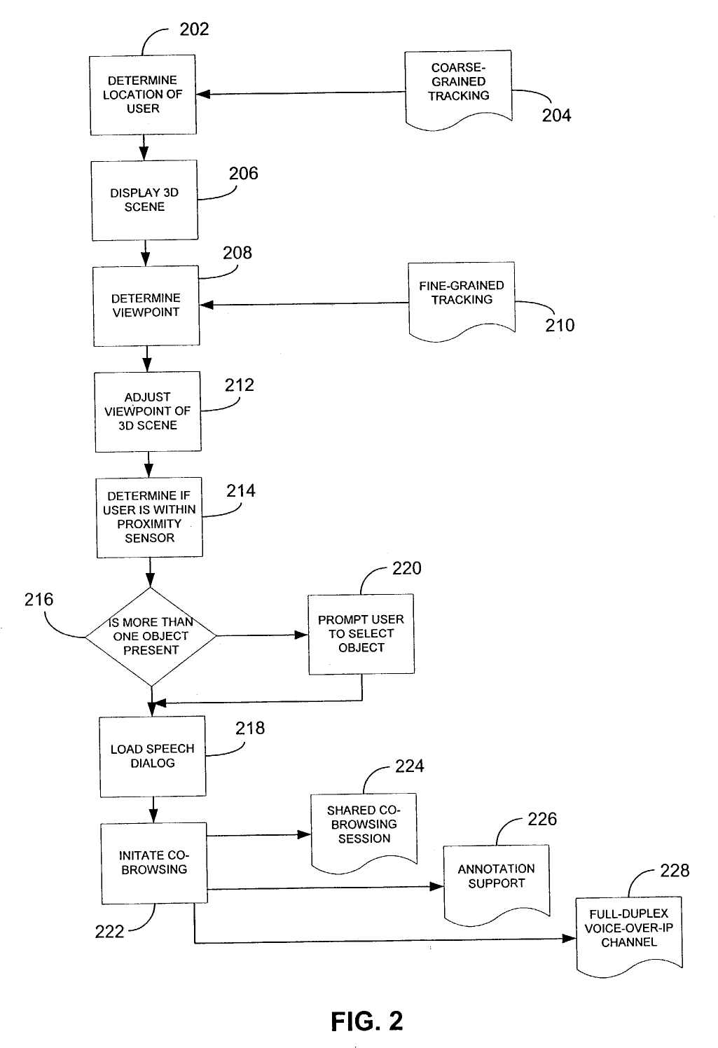

The mobile reality framework in accordance with various embodiments of the present invention runs in a networked computing environment where a user navigates a site or facility utilizing a mobile device or apparatus. The mobile device receives location information while roaming within the system to make location-specific information available to the user when needed. The mobile reality system according to an embodiment of the present invention does not have a distributed client/server architecture, but instead the framework runs entirely on a personal digital assistant (PDA), such as a regular 64 Mb Compaq iPAQ equipped with wireless LAN access and running the Microsoft™ Pocket PC operating system. As can be appreciated from FIG. 1, the mobile reality framework 100 comprises four main components: hybrid tracking 102, 3D graphics management 104, speech interaction 106 and collaboration support 108. Each of these components will be described in detail below with reference to FIG. 1 and FIG. 2 which illustrates a method of navigating a site utilizing the mobile reality framework.

Hybrid Tracking Solution

One aim of the system is to provide an intuitive multimodal interface that facilitates a natural, one-handed navigation of a virtual environment. Hence, as the user moves around in the physical world their location and orientation is tracked and the camera position, e.g., a viewpoint, in the 3D scene is adjusted correspondingly to reflect the movements.

While a number of single tracking technologies are available, it is recognized that the most successful indoor tracking solutions comprise two or more tracking technologies to create a holistic sensing infrastructure able to exploit the strengths of each technology.

Two complementary techniques are used to accomplish this task, one technique for coarse-grained tracking to determine location (step 202) and another for fine-grained tracking to determine orientation (step 208). Infrared beacons 110 able to transmit a unique identifier over a distance, e.g., approximately 8 meters, provide coarse-grained tracking (step 204), while a three degrees-of-freedom (3 DOF) inertia tracker 112 from a head-mounted display provides fine-grained tracking (step 210). Hence, a component was developed that manages and abstracts this hybrid tracking solution and exposes a uniform interface to the framework.

An XML resource is read by the hybrid tracking component 102 that relates each unique infrared beacon identifier to a three-dimensional viewpoint in a specified VRML scene. The infrared beacons 110 transmit their unique identifiers twice every second. When the hybrid tracking component 102 reads a beacon identifier from an IR sensor in one embodiment, it is interpreted in one of the following ways:

Known beacon: If not already loaded, the 3D graphics management component loads a specific VRML scene and sets the camera position to the corresponding viewpoint (step 202).

Unknown beacon: No mapping is defined in the XML resource for the beacon identifier encountered.

The 3 DOF inertia tracker 112 is connected via a serial/USB port to the apparatus. Every 100 ms the hybrid tracking component 102 polls the inertia tracker 112 to read the values of pitch (x-axis) and yaw (y-axis) (step 210). Again, depending upon the values received, the data is interpreted in one of the following ways:

Yaw-value: The camera position, e.g., viewpoint, in the 3D scene is adjusted accordingly (step 212). A tolerance of ±5 degrees was introduced to mitigate excessive jitter.

Pitch-value: A negative value moves the camera position in the 3D scene forwards, while a positive value moves the camera position backwards. The movement forwards or backwards in the scene is commensurate with the depth of the tilt of the tracker.

One characteristic of the inertia tracker 112 is that over time it drifts out of calibration. This effect of drift is somewhat mitigated if the user moves periodically between beacons. As an alternative embodiment, a chipset could be incorporated into the apparatus in lieu of employing the separate head-mounted inertia tracker.

The hybrid tracking component 102 continually combines the inputs from the two sources to calculate and maintain the current position (step 202) and orientation of the user (step 208). The mobile reality framework is notified as changes occur, but how this location information is exploited is described below.

The user can always disable the hybrid tracking component 102 by unchecking a tracking checkbox on the user interface. In addition, at any time the user can override and manually navigate the 3D scene by using either a stylus or joystick incorporated in the apparatus.

3D Graphics Management

One important element of the mobile multimodal interface is that of a 3D graphics management component 104. Hence, as the hybrid tracking component 102 issues a notification that the user's position has changed, the 3D graphics management component 104 interacts with a VRML component to adjust the camera position and maintain real-time synchronization between them. The VRML component has an extensive programmable interface.

The ability to offer location and context-sensitive speech interaction is a key aim of the present invention. The approach selected was to exploit a VRML element called a proximity sensor. Proximity sensor elements are used to construct one or more invisible cubes that envelope any arbitrarily complex 3D objects in the scene that are to be speech-enabled. When the user is tracked entering one of these demarcated volumes in the physical world, which is subsequently mapped into the VRML view on the apparatus, the VRML component issues a notification to indicate that proximity sensor has been entered (step 214). A symmetrical notification is also issued when a proximity sensor is left. The 3D graphics management component forwards these notifications and hence enables proactive location-specific actions to be taken by the mobile reality framework.

Speech Interaction Management

No intrinsic support for speech technologies is present within the VRML standard, hence a speech interaction management component 106 was developed to fulfill this requirement. As one example, the speech interaction management component integrates and abstracts the ScanSoft™ RealSpeak™ TTS (text-to-speech) engine and the Siemens™ ICM Speech Recognition Engine. As mentioned above, the 3D virtual counterparts of the physical objects nominated to be speech-enabled are demarcated using proximity sensors.

An XML resource is read by the speech interaction management component 106 that relates each unique proximity sensor identifier to a speech dialog specification. This additional XML information specifies the speech recognition grammars and the corresponding parameterized text string replies to be spoken (step 218). For example, when a maintenance engineer approaches a container tank he or she could enquire, “Current status?” To which the container tank might reply, “34% full of water at a temperature of 62 degrees Celsius.” Hence, if available, the mobile reality framework could obtain the values of “34”, “water” and “62” and populate the reply string before sending it to the TTS (text-to-speech) engine to be spoken.

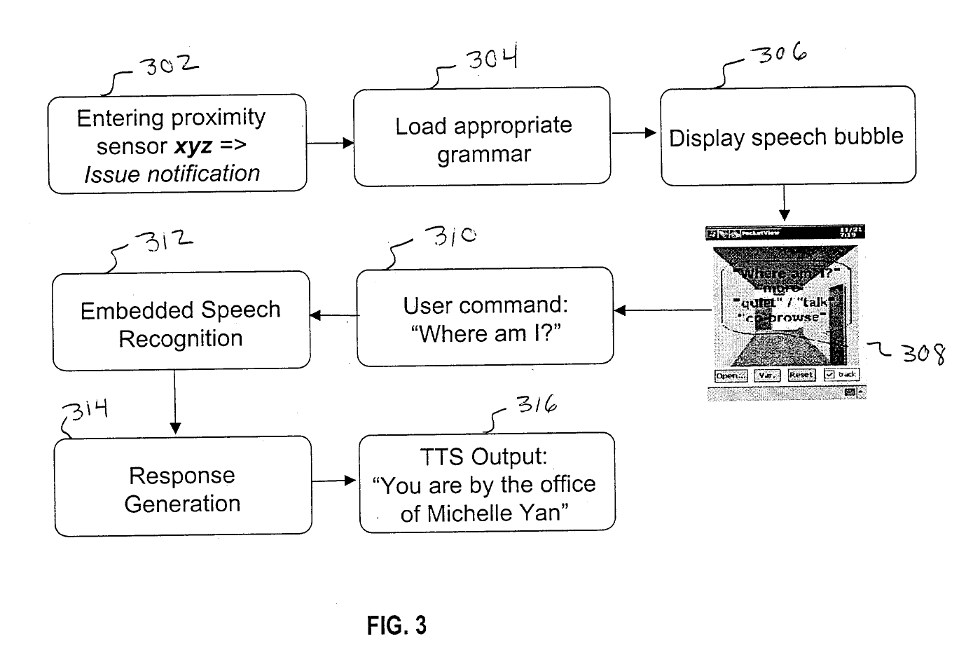

Recent speech technology research has indicated that when users are confronted with a speech recognition system and are not aware of the permitted vocabulary, they tend to avoid using the system. To circumvent this situation, when a user enters the proximity sensor for a given 3D object the available speech commands can either be announced to the user, displayed on a “pop-up” transparent speech bubble sign, or even both (step 218). FIG. 3 illustrates the speech interaction process.

Referring to FIG. 3, when the speech interaction management component receives a notification that a proximity sensor has been entered (step 302), it extracts from the XML resource the valid speech grammar commands associated with that specific proximity sensor (step 304). A VRML text node can then be dynamically generated containing valid speech commands and displayed to the user (step 306), e.g., “Where am I?”, “more”, “quiet/talk”, and “co-browse” 308. The user can then repeat one of the valid speech commands (step 310) which will be interpreted by an embedded speech recognition component (step 312). The apparatus will then generated the appropriate response (step 314) and send the response to the TTS engine to audibly produce the response (step 316).

When the speech interaction management component receives a notification that the proximity sensor has been left, the speech bubble is destroyed. The speech bubbles makes no attempt to follow the user's orientation. In addition, if the user approaches the speech bubble from the “wrong” direction, the text is unreadable as it is in reverse. The appropriate use of a VRML signposting element will address this limitation.

When the speech recognition was initially integrated, the engine was configured to listen for valid input indefinitely upon entry into speech-enabled proximity sensor. However, this consumed too many processor cycles and severely impeded the VRML rendering. The solution chosen requires the user to press a record button on the side of the apparatus prior to issuing a voice command.

Referring again to FIGS. 1 and 2, it is feasible for two overlapping 3D objects in the scene, and by extension the proximity sensors that enclose them, to contain one or more identical valid speech grammar commands (step 216). This raises the problem of to which 3D object should the command be directed. The solution is to detect automatically the speech command collision and resolve the ambiguity by querying the user further as to which 3D object the command should be applied (step 220).

Mobile Collaboration Support

At any moment, the user can issue a speech command to open a collaborative session with a remote party (step 222). In support of mobile collaboration, the mobile reality framework offers three features: (1) a shared 3D co-browsing session (step 224); (2) annotation support (step 226); and (3) full-duplex voice-over-IP channel for spoken communication (step 228).

A shared 3D co-browsing session (step 224) enables the following functionality. As the initiating user navigates through the 3D scene on their apparatus, the remote user can also simultaneously experience the same view of the navigation on his device—with the exception of network latency. This is accomplished by capturing the coordinates of the camera position, e.g., viewpoint, during the navigation and sending them over the network to a remote system of the remote user, e.g., a desktop computer, laptop computer or PDA. The remote system receives the coordinates and adjusts the camera position accordingly. A simple TCP sockets-based protocol was implemented to support shared 3D co-browsing. The protocol includes:

Initiate: When activated, the collaboration support component prompts the user to enter the network address of the remote party, and then attempts to connect/contact the remote party to request a collaborative 3D browsing session.

Accept/Decline: Reply to the initiating party either to accept or decline the invitation. If accepted, a peer-to-peer collaborative session is established between the two parties. The same VRML file is loaded by the accepting apparatus.

Passive: The initiator of the collaborative 3D browsing session is by default assigned control of the session. At any stage during the co-browsing session, the person in control can select to become passive. This has the effect of passing control to the other party.

Hang-up: Either party can terminate the co-browsing session at any time.

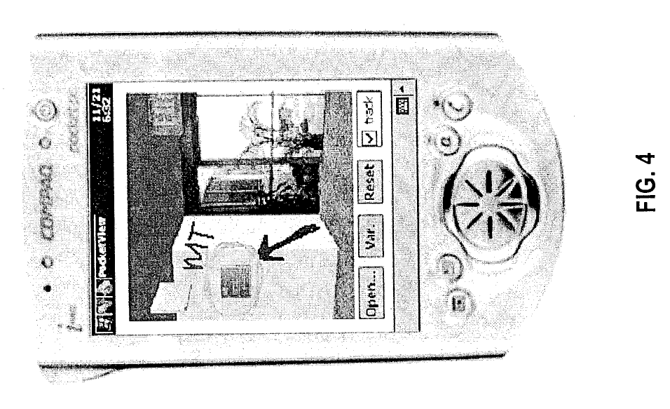

Preferably, the system can support shared dynamic annotation of the VRML scene using colored ink, as shown in FIG. 4 which illustrates a screen shot of a 3D scene annotated by a remote party.

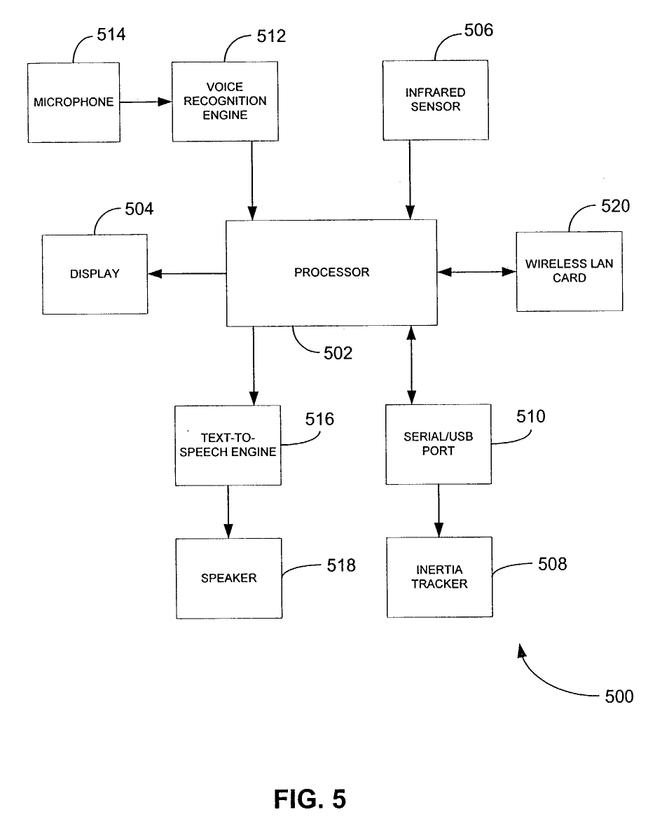

FIG. 5 illustrates an exemplary mobile reality apparatus in accordance with an embodiment of the present invention. The mobile reality apparatus 500 includes a processor 502, a display 504 and a hybrid tracking system for determining a position and orientation of a user. The hybrid tracking system includes a coarse-grained tracking device and a fine-grained tracking device. The coarse-grained device includes an infrared sensor 506 to be used in conjunction with infrared beacons located throughout a site or facility. The fine-grained tracking device includes an inertia tracker 508 coupled to the processor 502 via a serial/USB port 510. The coarse-grained tracking is employed to determine the user's position while the fine-grained tracking is employed for determining the user's orientation.

The mobile reality apparatus further includes a voice recognition engine 512 for receiving voice commands from a user via a microphone 514 and converting the commands into a signal understandable by the processor 502. Additionally, the apparatus 500 includes a text-to-speech engine 516 for audibly producing possible instructions to the user via a speaker 518. Furthermore, the apparatus 500 includes a wireless communication module 520, e.g., a wireless LAN (Local Area Network) card, for communicating to other systems, e.g., a building automation system (BAS), over a Local Area Network or the Internet.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

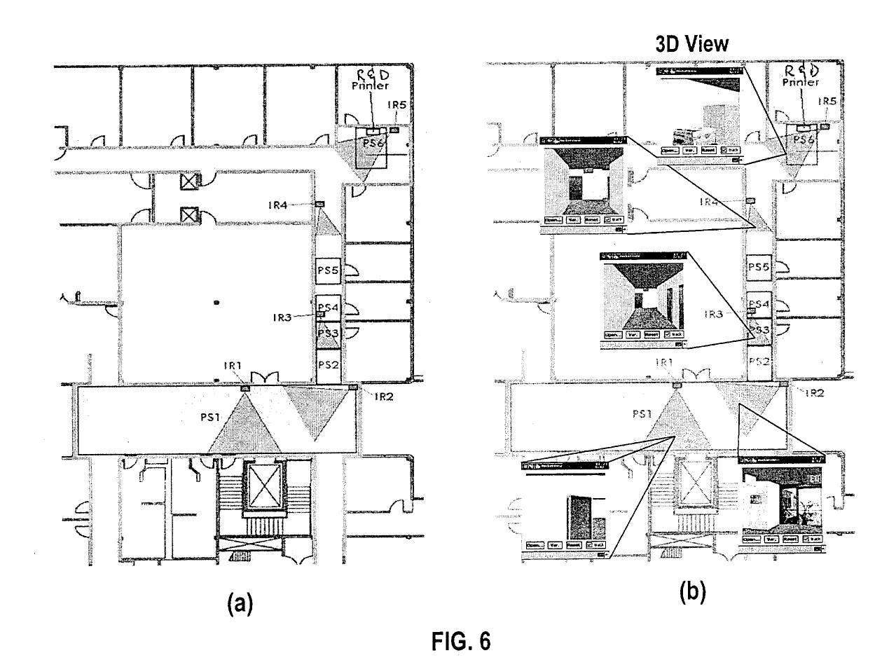

To illustrate various embodiments of the present invention, an exemplar application is presented that makes use of much of the mobile reality functionality. The application is concerned with mobile maintenance. A 2D floor plan of an office building can be seen in FIG. 6(a). It has been augmented to illustrate the positions of five infrared beacons (labeled IR1 to IR5) and their coverage zones, and six proximity sensor regions (labeled PS1 to PS6). The corresponding VRML viewpoint for each infrared beacon can be appreciated in FIG. 6(b).

The mobile maintenance technician arrives to fix a defective printer. He enters the building and when standing in the intersection of IR1 and PS1 (see FIG. 6(a)) turns on his mobile reality apparatus 500 and starts mobile reality. The mobile reality apparatus detects beacon IR1 and loads the corresponding VRML scene, and, as he is standing in PS1, the system informs him of his current location. The technician does not know the precise location of the defective printer so he establishes a collaborative session with a colleague, who guides him along the correct corridor using the 3D co-browsing feature. While en-route they discuss the potential problems over the voice channel.

When the printer is in view, they terminate the session. The technician enters PS6 as he approaches the printer, and the system announces that there is a printer in the vicinity called “R&D Printer”. A context-sensitive speech bubble appears on his display listing the available speech commands. The technician issues a few of the available speech commands that mobile reality translates into diagnostic tests on the printer, the parameterized results of which are then verbalized or displayed by the system.

If further assistance is necessary, he can establish another 3D co-browsing session with a second level of technical support in which they can collaborate by speech and annotation on the 3D printer object. If the object is complex enough to support animation, then it may be possible to collaboratively explode the printer into its constituent parts during the diagnostic process.

A mobile reality system and methods thereof have been provided. The mobile reality framework disclosed offers a mobile multimodal interface for assisting with tasks such as a mobile maintenance. The mobile reality framework enables a person equipped with a mobile device, such as a Pocket PC, PDA, mobile telephone, etc., to walk around a building and be tracked using a combination of techniques while viewing on the mobile device a continuously updated corresponding personalized 3D graphical model. In addition, the mobile reality framework also integrates text-to-speech and speech-recognition-technologies that enables the person to engage in a location/context sensitive speech dialog with the system.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method for navigating a site, the method comprising the steps of:
determining a location of a user by receiving a location signal from a location-dependent device;
loading and displaying a three-dimensional (3D) scene of the determined location;
determining an orientation of the user by a tracking device;
adjusting a viewpoint of the 3D scene by the determined orientation;
determining if the user is within a predetermined distance of an object of interest; and
loading a speech dialog of the object of interest.

2. The method as in claim 1, wherein if the user is within a predetermined distance of a plurality of objects of interest, prompting the user to select at least one object of interest.

3. The method as in claim 1, wherein the speech dialog is displayed to the user.

4. The method as in claim 1, wherein the speech dialog is audibly produced to the user.

5. The method as in claim 1, further comprising the step of querying a status of the object of interest by the user.

6. The method as in claim 5, further comprising the step of informing the user of the status of the object of interest.

7. The method as in claim 1, further comprising the step of initiating by the user a collaboration session with a remote party for instructions.

8. The method as in claim 7, wherein the remote party annotates the displayed viewpoint of the user.

9. The method as in claim 7, wherein the remote party views the displayed viewpoint of the user.

10. A system for navigating a user through a site, the system comprising:
a plurality of location-dependent devices for transmitting a signal indicative of each devices' location; and
a navigation device for navigating the user including:
a tracking component for receiving the location signals and for determining a position and orientation of the user;
a graphic management component for displaying scenes of the site to the user on a display; and
a speech interaction component for instructing the user.

11. The system as in claim 10, wherein the tracking component includes a coarse-grained tracking component for determining the user's location and a fine-grained tracking component for determining the user's orientation.

12. The system as in claim 11, wherein the coarse-grained tracking component includes an infrared sensor for receiving an infrared location signal from at least one of the plurality of location-dependent devices.

13. The system as in claim 11, wherein the fine-grained tracking component is an inertia tracker.

14. The system as in claim 10, wherein the graphic management component includes a three dimensional graphics component for modeling a scene of the site.

15. The system as in claim 10, wherein the graphic management component determines if the user is within a predetermined distance of an object of interest and, if the user is within the predetermined distance, the speech interaction component loads a speech dialog associated with the object of interest.

16. The system as in claim 15, wherein the speech dialog is displayed on the display.

17. The system as in claim 15, wherein the speech dialog is audibly produced by a text-to-speech engine.

18. The system as in claim 10, wherein the speech interaction component includes a text-to-speech engine for audibly producing instructions to the user.

19. The system as in claim 10, wherein the speech interaction component includes a voice recognition engine for receiving voice commands from the user.

20. The system as in claim 10, wherein the navigation device further includes a wireless communication module for communicating to a network.

21. The system as in claim 10, wherein the navigation device further includes a collaboration component for the user to collaborate with a remote party.

22. A navigation device for navigating a user through a site comprising:
a tracking component for receiving location signals from a plurality of location-dependent devices and for determining a position and orientation of the user;
a graphic management component for displaying scenes of the site to the user on a display; and
a speech interaction component for instructing the user.

23. A program storage device readable by a machine, tangibly embodying a program of instructions executable by the machine to perform method steps for navigating a site, the method steps comprising:
determining a location of a user by receiving a location signal from a location-dependent device;
loading and displaying a three-dimensional (3D) scene of the determined location;
determining an orientation of the user by a tracking device; and
adjusting a viewpoint of the 3D scene by the determined orientation;
determining if the user is within a predetermined distance of an object of interest; and
loading a speech dialog of the object of interest.
